(19) United States
(12) Patent Application Publication
(10) Pub. No.: US 2005/0209894 A1
(43) Pub. Date: Sep. 22, 2005

(54) Systems and devices for vision protection policy

(75) Inventors: Christy Wilson, Smiths, AL (US); Katherine Gant, Columbus, GA (US); Mark C. Massey, Auburn, AL (US); Tom Morey, Columbus, GA (US); JoAnn King, Columbus, GA (US); Deborah Grantham, Woodland, GA (US); Wendy Herndon, Columbus, GA (US); Karen Riedel, Phenix City, AL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: AFLAC

(21) Appl. No.: 11/137,207

(22) Filed: May 25, 2005

Related U.S. Application Data
(60) Provisional application No. 60/634,883, filed on Dec. 10, 2004.

(51) Int. Cl. G06F 17/60

(52) U.S. Cl. 705/4

(57) ABSTRACT

A system and computing device for issuing a vision protection policy providing both a routine eye care benefit and one or more of the following benefits: (1) an eye condition benefit; (2) an eye surgery benefit; and (3) a permanent visual impairment benefit are provided. A system for processing a claim received from a vision protection policyholder is also provided.

### CROSS-REFERENCE TO PROVISIONAL APPLICATION

The present application claims priority from U.S. Provisional Application No. 60/634,883 filed Dec. 10, 2004, the contents of which are hereby incorporated herein by reference in their entirety.

### BACKGROUND OF THE INVENTION

Current eye care policies typically provide policyholders with annual eye examinations and free or reduced-cost vision correction products, such as eyeglasses or contact lenses. However, there is a need for improved insurance policies that provide additional types of vision-related coverage.

### BRIEF SUMMARY OF THE INVENTION

Generally described, various embodiments of the present invention provide an improvement over the known prior art by providing a system and computing device for issuing a vision protection policy that provides policyholders with vision-related coverage that is in addition to routine coverage for eye examinations and/or vision correction products. A system for processing a claim received by a vision protection policyholder is also provided.

According to one aspect of the present invention, a system for issuing a vision protection policy is provided. One embodiment of the system includes a processor and a memory coupled to the processor and storing an application that the processor executes to: (1) receive applicant data related to a prospective policy participant; (2) apply one or more business rules stored in the memory to the applicant data to determine whether the prospective policy participant qualifies for the vision protection policy; and (3) transmit the vision protection policy to a policy participant, wherein the policy participant is comprised of the prospective policy participant determined to qualify for the vision protection policy. In this embodiment, the vision protection policy provides a combination of a routine eye care benefit and one or more of an eye condition benefit, an eye surgery benefit, and a permanent visual impairment benefit.

In one embodiment, the routine eye care benefit provided by the vision protection policy is comprised of an eye examination benefit that at least partially covers a cost associated with at least one medical examination of the policy participant's eyes. In another embodiment, the routine eye care benefit further includes a vision correction benefit that at least partially covers a cost associated with purchasing one or more vision correction materials. In one embodiment, the vision correction benefit further provides for a vision correction payment to be made to the policy participant in response to the policy participant undergoing a medical procedure to improve the policy participant's vision.

In one embodiment, the eye condition benefit of the vision protection policy provides for one or more eye condition benefit payments to be made in response to the policy participant being diagnosed with a particular eye disease or disorder. According to another embodiment, the eye surgery benefit provides for one or more eye surgery benefit payments to be made to the policy participant in response to the policy participant undergoing a surgical procedure related to a particular eye disease or disorder. In yet another embodiment, the visual impairment benefit of the vision protection policy provides for at least one payment to be made in response to the policy participant being diagnosed with a visual impairment for which there is no, or substantially no, reasonable prognosis of recovery.

According to another aspect of the present invention, a system for processing a vision protection policy claim is provided. One embodiment of the system includes a processor and a memory coupled to the processor and storing an application that the processor executes to: (1) receive a vision protection policy claim from a policy participant; (2) determine whether the policy participant incurred one or more expenses relating to routine eye care; (3) determine whether the policy participant has been diagnosed with an eye disease or disorder; (4) determine whether the policy participant has undergone a surgical procedure related to an eye disease or disorder; (5) determine whether the policy participant has been diagnosed with a visual impairment for which there is no, or substantially no, reasonable medical prognosis of recovery; and (6) authorize provision of a combination of a routine eye care benefit, an eye condition benefit, an eye surgery benefit, and a permanent visual impairment benefit based on the determinations made in steps (2) through (5).

According to yet another aspect of the invention, a computing device is provided. One embodiment of the device includes a processor and a memory coupled to the processor and storing an application that the processor executes to: (1) receive applicant data pertaining to a vision protection policy from a prospective policy participant; and (2) transmit the applicant data to an insurance company computer. In this embodiment the vision protection policy provides a combination of a routine eye care benefit and one or more of an eye condition benefit, an eye surgery benefit, and a permanent visual impairment benefit, and the applicant data relates to this combination of benefits.

### BRIEF DESCRIPTION OF THE DRAWING(S)

Having thus described the invention in general terms, reference will now be made to the accompanying drawings, which are not necessarily drawn to scale, and wherein:

FIG. 1 is a block diagram of a system for issuing a vision protection policy according to one embodiment of the present invention;

FIG. 2 is a block diagram of an Insurance Company computer in accordance with one embodiment of the present invention;

FIG. 3 is a block diagram of a Computing Device in accordance with one embodiment of the present invention;

FIG. 4 is a flow chart illustrating a method of issuing a vision protection policy according to an embodiment of the present invention;

FIG. 5 is a block diagram of a system for processing a vision protection policy claim according to one embodiment of the present invention;

FIG. 6 is a block diagram of a claim Processing Server in accordance with embodiments of the present invention; and

FIG. 7 is a flow chart illustrating a method of processing a vision protection policy claim according to a particular embodiment of the present invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Vision Protection Policy

A vision care and protection policy (also referred to as a “vision policy” or a “vision protection policy”) according to a particular embodiment of the invention comprises both a routine eye care benefit and one or more of the following benefits: (1) an eye condition benefit; (2) an eye surgery benefit; and (3) a permanent visual impairment benefit. Exemplary routine eye care benefits, eye condition benefits, eye surgery benefits, and permanent visual impairment benefits are described below.

Routine Eye Care Benefits

In various embodiments of the invention, a routine eye care benefit includes an eye examination benefit and/or a vision correction benefit. An eye examination benefit provides, for example, for a predetermined payment to be made when a charge is incurred for an eye examination for a person covered by the vision policy (a “policy participant”). In various embodiments, this payment may be made directly to the policy participant. In certain embodiments of the invention, the vision policy may provide for policy participants to receive one or more eye examinations at no cost, or substantially no cost, to the policy participant.

A vision correction benefit provides, for example, for a predetermined vision correction payment to be made when a policy participant purchases one or more vision correction materials. In one embodiment of the invention, the vision correction materials may include eyeglasses and/or contact lenses. The vision correction payment may be made, for example, directly to the policy participant. In certain embodiments of the invention, the vision policy may provide for policy participants to receive the vision correction materials at no cost, or substantially no cost, to the policy participant.

Also, in various embodiments of the invention, the vision correction benefit provides for a vision correction payment to be made to the policy participant in response to the policy participant undergoing a medical procedure to improve said policy participant's vision. Such a medical procedure may include, for example, refractive error correction surgery.

Eye Condition Benefit

A typical eye condition benefit provides for one or more eye condition benefit payments to be made in response to a policy participant being diagnosed with a particular eye disease or eye disorder. In various embodiments of the invention, such eye diseases and disorders may include, for example: glaucoma, proliferative diabetic retinopathy, macular degeneration, retinal detachment, and retinitis pigmentosa.

In certain embodiments of the invention, the vision policy provides that the eye condition benefit payments are to be paid regardless of other insurance coverage (and preferably regardless of any insurance coverage) that the policy participant may have for medical care related to the particular eye disease or disorder at issue. For example, in one embodiment, if the policy participant has other insurance coverage that would pay for treatment of a particular eye disease or disorder, any payments to be made under the vision policy would still be made if the policy participant were diagnosed with the particular eye disease or disorder. In a particular embodiment of the invention, the one or more eye condition benefit payments include a payment of a pre-defined amount (e.g., $1,000) to be made to the policy participant.

Eye Surgery Benefit

A typical eye surgery benefit provides for one or more eye surgery benefit payments to be made in response to a policy participant undergoing a surgical procedure related to a particular eye disease or disorder. The following table includes an exemplary listing of one-time eye surgery benefit payments to be made to a policy participant in response to the policy participant undergoing a corresponding listed surgical procedure:

SCHEDULE OF OPERATIONS

| | |
|---|---|
| Cornea Transplant | $1,500 |
| Cataracts | |
| Removal | $800 |
| Discission | $400 |
| Glaucoma | |
| Fistulization of sclera | $800 |
| Iriodotomy/Iridectomy | $400 |
| Eye Cancer and Tumors | |
| Radiation implant, with removal | $1,200 |
| Destruction by Photocoagulation | $800 |
| Destruction by Cryotherapy | $800 |
| Excision of gland tumor | $800 |
| Retinopathy | |
| Destruction by Photocoagulation | $800 |
| Destruction by Cryotherapy | $800 |
| Retinal Detachment Repair | $1,000 |
| Miscellaneous Eye Surgeries | |
| Exenteration of orbit | $1,500 |
| Keratoprosthesis | $1,500 |
| Orbitotomy | |
| with bone flap | $1,500 |
| without bone flap | $1,000 |
| Evisceration of ocular contents | $800 |
| Enucleation of eye | $800 |
| Insertion of ocular implant | $800 |
| Removal of blood clot, | $800 |
| anterior segment of eye | |
| Removal of foreign body | |
| from anterior chamber or lens | $800 |
| external eye | $50 |
| Repair of laceration, cornea, | $400 |
| sclera, or conjunctiva | |
| Cilary Body destruction | $400 |
| Excision of lesion, other | $200 |
| than chalazion | |
| Excision of chalazion | $100 |

In certain embodiments of the invention, the vision policy provides that eye surgery benefit payments are to be paid regardless of other insurance coverage (and preferably regardless of any insurance coverage) that the policy participant may have for the surgical procedure at issue. For example, in one embodiment, if the policy participant has other insurance coverage that would pay for the removal of cataracts in one of the policy participant's eyes, the provider of the vision policy would still make a payment of $800 to the policy participant.

Permanent Visual Impairment Benefit

A permanent visual impairment benefit according to one embodiment of the invention provides for at least one visual impairment payment to be made in response to the policy participant being diagnosed with a visual impairment for which there is no, or substantially no, reasonable medical prognosis of recovery. In particular, in one embodiment of the invention, the provider of the vision policy will pay the indemnity amounts listed below for the specific level (or levels) of visual impairment that apply to the policy participant's diagnosed stage of visual impairment.

| | | MAXIMUM |
|---|---|---|
| VISUAL IMPAIRMENT | | CUMULATIVE |
| LEVEL | TOTAL PER LEVEL | BENEFIT PER EYE |
| (Level 1) - Severe | $750 | $750 |
| (Level 2) - Profound | +$1,750 | $2,500 |
| (Level 3) - Near-Total | +$2,500 | $5,000 |
| (Level 4) - Total | +$5,000 | $10,000 |

As may be understood from the above table, in certain embodiments, if a policy participant is diagnosed with a Level 2, 3, or 4 visual impairment, benefits for previously unpaid lower levels of visual impairment will be paid in addition to benefits for the level diagnosed. For example, if a policy participant is diagnosed with a profound (Level 2) visual impairment, in the embodiment of the invention described above, the participant would receive a payment of $2,500 (which is the sum of (1) a payment of $1,750 for a Level 2 visual impairment and (2) a payment of $750 for a Level 1 visual impairment). In one embodiment of the invention, each level of visual impairment is payable up to a maximum of once per eye, per policy participant.

In one embodiment of the invention, a policy participant's level of visual impairment is determined as follows:
(LEVEL 1) SEVERE VISUAL IMPAIRMENT: Maximal visual acuity, after correction, of 20/200 or less, or a total diameter of the visual field in that eye of 20 degrees or less.
(LEVEL 2) PROFOUND VISUAL IMPAIRMENT: Maximal visual acuity, after correction, of 20/500 or less, or a total diameter of the visual field in that eye of 10 degrees or less.
(LEVEL 3) NEAR-TOTAL VISUAL IMPAIRMENT: Maximal visual acuity, after correction, less than 20/1000, or a total diameter of the visual field in that eye of 5 degrees or less.
(LEVEL 4) TOTAL VISUAL IMPAIRMENT: Complete loss of vision with no remaining perception of light, or loss of the natural eye.

In certain embodiments of the invention, the vision policy provides that visual impairment payments are to be paid regardless of other insurance coverage (and preferably regardless of any insurance coverage) that the policy participant may have that is related to the visual impairment at issue.

Issuing Policy

System Architecture

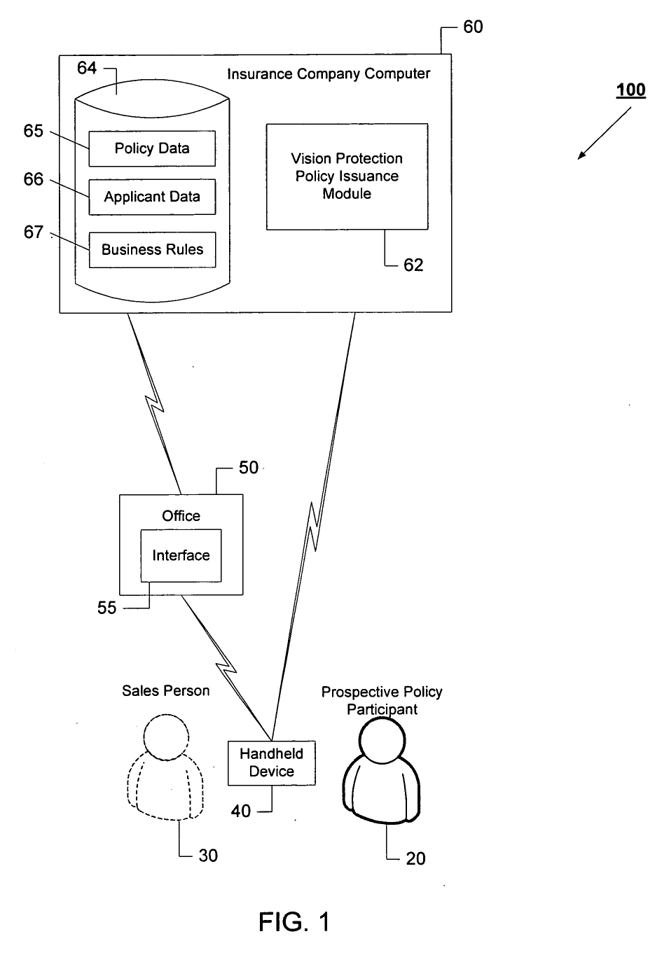

FIG. 1 shows a block diagram of a system for issuing a vision protection policy 100 in accordance with various embodiments of the present invention. As may be understood from this figure, the system 100 may include a prospective policy participant 20 in contact with a salesperson 30 having a computing device 40, into which the salesperson 30 can enter Applicant data received from the prospective policy participant 20. As can be appreciated by one of ordinary skill in the art, the computing device 40 may be any type of computing device, including, for example, a mobile telephone, personal data assistant (PDA), laptop or mobile personal computer (PC), desktop unit, or workstation.

The system further includes an office 50 in communication with the handheld device 40, and an Insurance Company computer 60 in communication with the office 50. The office 50, which may be operated directly by the Insurance Company or by some other entity affiliated with the Insurance Company, includes at least an interface 55 to facilitate the communication of Applicant data between the handheld device 40 and the Insurance Company computer 60. The interface 55 may be any known interface including, for example, a docking station that is connected to an IT infrastructure, such as a Local Area Network (LAN), Wide Area Network (WAN), or the Internet. Data can, therefore, be communicated from the office 50 to the Insurance Company computer 60 via any known means of communicating data including, for example, via the Internet, via a cable connection, by fax, via a telephone network, or even by a human operator located at the office 50.

Alternatively, the computing device 40 can be configured to communicate with the insurance company computer 60 directly without the need for office 50 and the interface 55. The computing device 40 can communicate with the Insurance Company computer 60 via a communications network such as the Internet, WAN, one or more LANs, wireless network, cellular network, etc.

The Insurance Company computer 60 includes at least a vision protection policy issuance module 62. The module 62 can be configured to retrieve data from, and store data to, a database 64. As shown, policy data 65, Applicant data 66 and business rules 67 can each be stored in the database 64 and accessed by the vision protection policy issuance module 62.

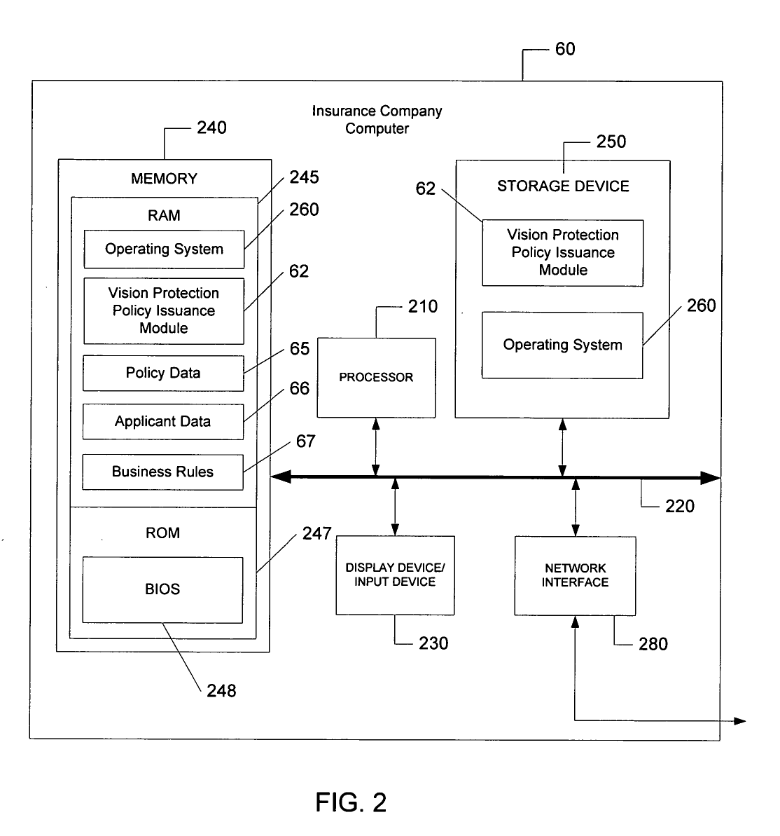

FIG. 2 shows a schematic diagram of the Insurance Company computer 60 according to one embodiment of the invention. The Insurance Company computer 60 includes a processor 210 that communicates with other elements within the Insurance Company computer 60 via a system interface or bus 220. The processor 210 could be, for example, a central processing unit, microprocessor, microcontroller, programmable gate array, or some other device that processes data. Also included in the Insurance Company computer 60 is a display device/input device 230 for receiving and displaying data. The unit 230 may include, for example, an input device such as a keyboard, mouse or pointing device, and a display device such as a monitor, cathode ray tube (CRT), liquid crystal display (LCD), or other such device. The Insurance Company computer 60 further includes a memory 240, which includes both random access memory (RAM) 245 and read only memory (ROM) 247. The computer's ROM 247 is used to store a basic input/output system 248 (BIOS), containing the basic routines that help to transfer information between elements within the Insurance Company computer 60. The computer's RAM 245 is used to store the policy data 65, Applicant data 66 and business rules 67.

In addition, the Insurance Company computer 60 includes at least one storage device 250, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 250 is connected to the system bus 220 by an appropriate interface. The storage devices 250 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices 250 and within RAM 245. Such program modules include an operating system 260, and the vision protection policy issuance module 270. The vision protection policy issuance module 270 controls certain aspects of the operation of the Insurance Company computer 60, as is described in more detail below, with the assistance of the processor 210 and the operating system 260.

Also located within the Insurance Company computer 60 is a network interface 280, for interfacing and communicating with other elements of a computer network. It will be appreciated by one of ordinary skill in the art that one or more of the Insurance Company computer 60 components may be located geographically remotely from other Insurance Company computer 60 components. Furthermore, one or more of the components may be combined, and additional components performing functions described herein may be included in the Insurance Company computer 60.

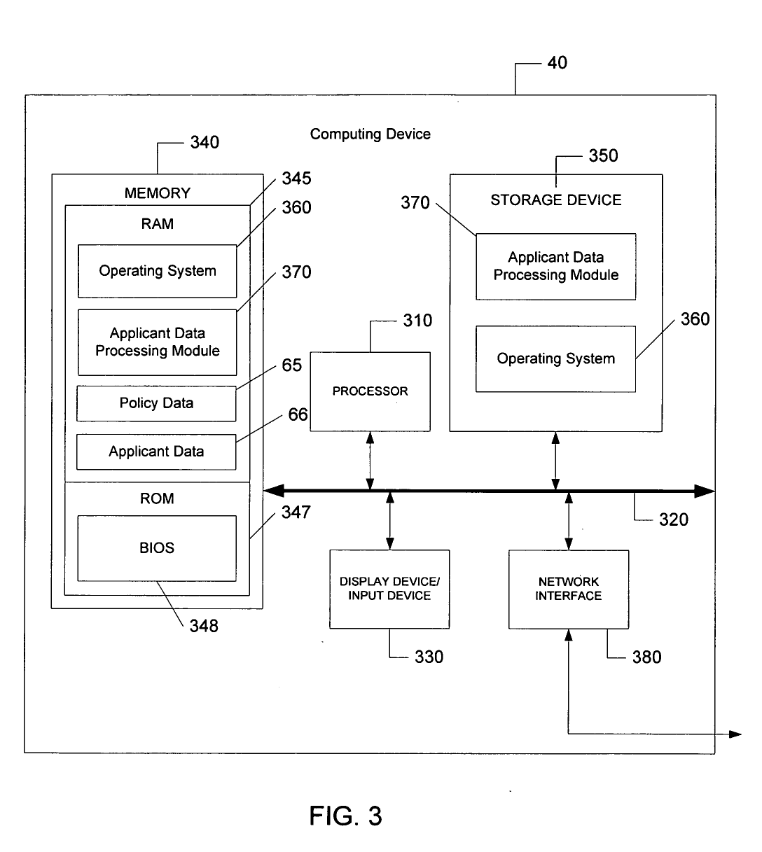

FIG. 3 shows a schematic diagram of the Computing Device 40 according to one embodiment of the invention. The Computing Device 40 is used by the prospective policy participant 20 or the salesperson 30, or both, to receive Applicant data 66 and to transfer the same to the Insurance Company computer 60. The elements of the Computing Device 40 shown in FIG. 3 are the same or similar to corresponding elements of the Insurance Company computer 60 shown in FIG. 2, with a few exceptions. In particular, the Computing Device 40 includes a processor 310 that communicates with other elements within the Computing Device 40 via a system interface or bus 320, a display device/input device 330 for receiving and displaying data, a memory 340, which includes both random access memory (RAM) 345 and read only memory (ROM) 347, wherein the ROM 347 is used to store a basic input/output system 348 (BIOS) and the RAM 345 is used to at least temporarily store policy data 65 and applicant data 66, at least one storage device 350, and a network interface 380, for interfacing and communicating with other elements of a computer network.

Like the Insurance Company computer 60, a number of program modules may be stored by the various storage devices 350 and within RAM 345. Such program modules include an operating system 360, and an applicant data processing module 370. The applicant data processing module 370 controls certain aspects of the operation of the Computing Device 40, as is described in more detail below, with the assistance of the processor 310 and the operating system 360.

Method of Issuing Vision Protection Policy

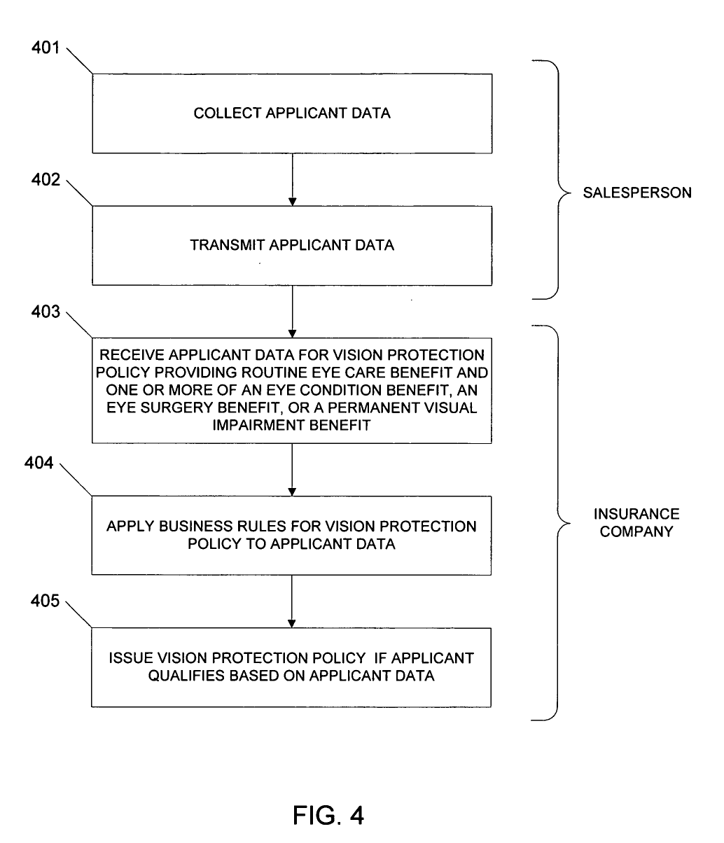

FIG. 4 illustrates the steps taken when issuing the above described vision protection policy according to one embodiment of the present invention. As shown, in one embodiment the process of issuing a vision protection policy begins at Step 401 in which a salesperson collects Applicant data 66 from a prospective policy participant and enters it into his or her computing device 40. In Step 402, the salesperson transmits the Applicant data 66 from the computing device 40 to the Insurance Company computer 60 using the application data processing module 370 on the computing device 40. The Applicant data collected may include, for example, the prospective policy participant's name, address or medical history, and/or other types of insurance coverage owned by the prospective policy participant.

In other embodiments, the process could likewise begin with a prospective policy participant entering his or her own Applicant data directly into an application form provided by the Insurance Company, and sending the application form to the Insurance Company. The application form could be in hard copy, requiring, for example, that the prospective policy participant enter the Applicant data by hand, and then mail or fax the form to the Insurance Company. The Applicant data could then be entered into the Insurance Company computer 60 by, for example, an Insurance Company employee. Alternatively, the application form could be provided over the Internet on a Web site operated by the Insurance Company, or by some other company affiliated with the Insurance Company. In this case the prospective policy participant could merely enter the data into the online version of the application form and then send the data electronically to the Insurance Company computer 60. In yet another embodiment, the prospective policy participant may contact an Insurance Company operator directly, by telephone or by other means, and communicate the Applicant data to the operator, who enters the data into the Insurance Company computer 60.

Once the Insurance Company computer 60 has received the Applicant data 66, in Step 403, the Insurance Company computer 60 stores the Applicant data 66 in a database 64 on the Insurance Company computer 60. The vision protection policy issuance module 62 then applies business rules 67, which are also stored in the database 64 on the Insurance Company computer 60, to the Applicant data 66 to determine whether the prospective policy participant qualifies for the vision protection policy (Step 404). This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical history and status are within risk parameters of the policy, determining whether the applicant has pre-existing conditions that should be excluded from policy coverage, determining whether the applicant is of legal age to enter a binding contract in the State in which a policy is sought, etc.

If the Insurance Company computer 60 determines that the applicant is not qualified for the policy based on the applicant data 66 and business rules 67, then the Insurance Company computer 60 rejects the application. Conversely, upon a determination by the Insurance Company computer 60 that the prospective policy participant qualifies for the vision protection policy, in Step 405 the Insurance Company issues the vision protection policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson.

Claim Processing

System Architecture

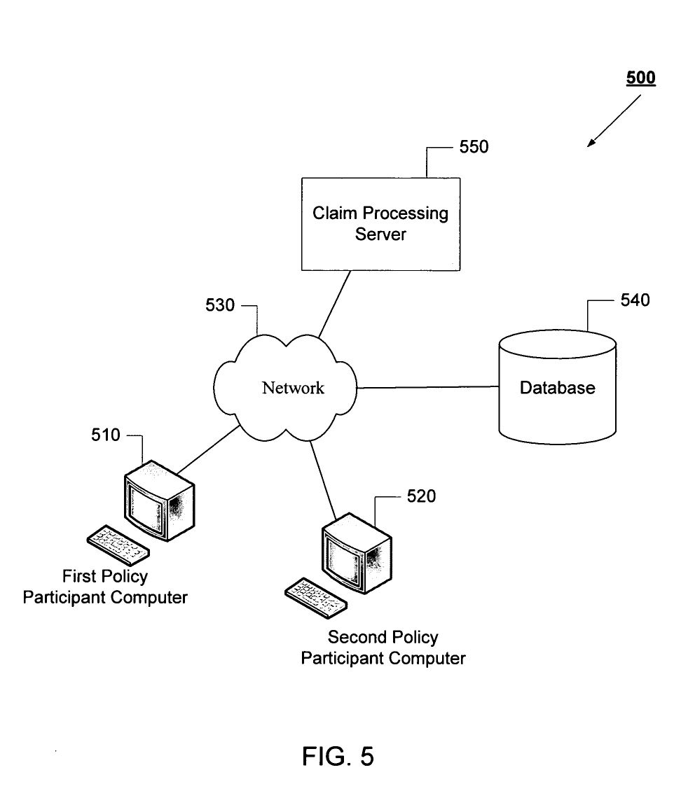

FIG. 5 shows a block diagram of a system 500 for processing a vision protection policy claim in accordance with various embodiments of the present invention. As may be understood from this figure, the system 500 may include one or more policy participant computers 510, 520 that are connected, via a network 530 (e.g., a Local Area Network (LAN), wide area network (WAN), or the Internet), to a claim Processing Server 550. In one embodiment, the claim Processing Server 550 is configured to retrieve data from, and store data to, a database 540 that may be stored on (or, alternatively, stored remotely from) the claim Processing Server 550.

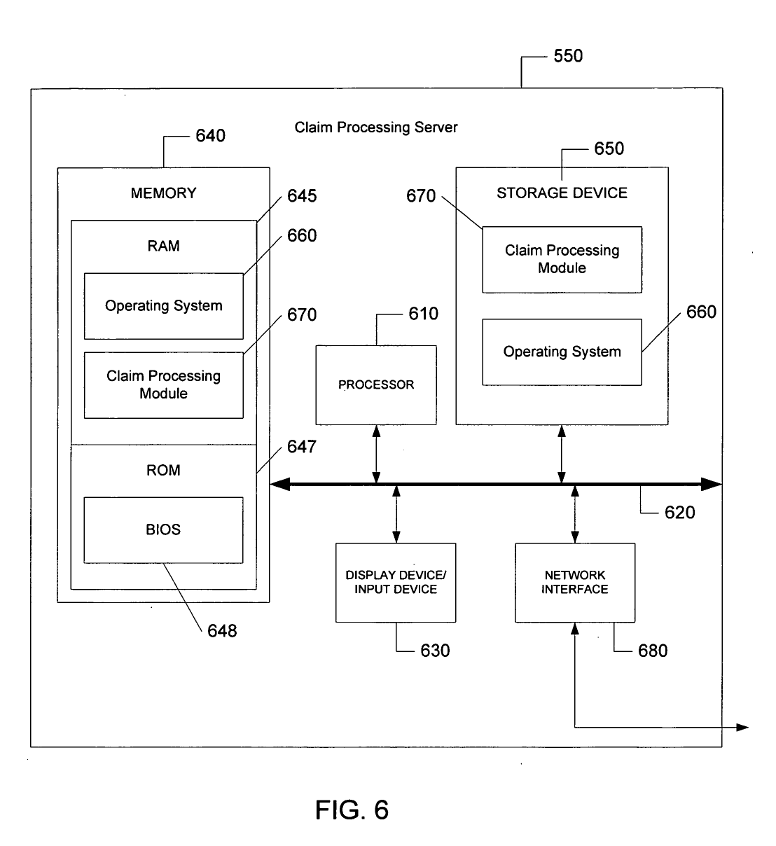

FIG. 6 shows a schematic diagram of the claim Processing Server 550 according to one embodiment of the invention. The elements of the claim Processing Server 550 shown in FIG. 6 are the same or similar to corresponding elements of the Insurance Company computer 60 shown in FIG. 2 and of the Computing Device 40 shown in FIG. 3, with a few exceptions. In particular, the claim Processing Server 550 includes a processor 610 that communicates with other elements within the claim Processing Server 550 via a system interface or bus 620, a display device/input device 630 for receiving and displaying data, a memory 640, which includes both random access memory (RAM) 645 and read only memory (ROM) 647, wherein the ROM 647 is used to store a basic input/output system 648 (BIOS), at least one storage device 650, and a network interface 680, for interfacing and communicating with other elements of a computer network.

Like the Insurance Company computer 60 and the Computing Device 40, a number of program modules may be stored by the various storage devices 650 and within RAM 645. Such program modules include an operating system 660, and a claim processing module 670. The claim processing module 670 controls certain aspects of the operation of the claim Processing Server 550, as is described in more detail below, with the assistance of the processor 610 and the operating system 660.

Method of Processing Vision Protection Policy claim

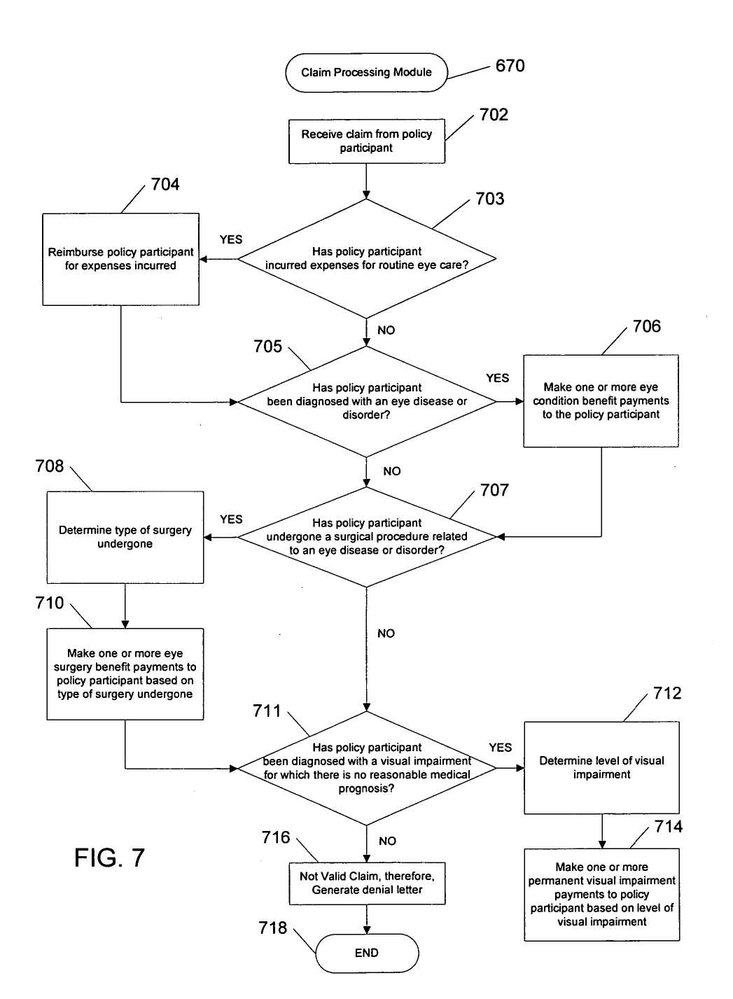

FIG. 7 depicts the claim Processing Module 670 according to one embodiment of the invention. In general, this figure illustrates the steps taken when processing a claim received from a vision protection policy participant according to various embodiments of the present invention. As may be understood from this figure, the system begins at Step 702 in which the claim Processing Module 670 on the claim Processing Server 550 receives a vision protection policy claim. As will be understood by those of skill in the art, the claim may have been communicated by the policy participant, for example, by telephone, mail, fax, or network (e.g., the Internet) by electronic, optical, or wireless media, for example. Once received, the claim Processing Module 670, in one embodiment, first determines, based on the claim received, whether the policy participant has incurred an expense for routine eye care (Step 703). The expense may include, for example, the cost of an eye examination, vision correction materials, or of undergoing a medical procedure to improve the policy participant's vision. The policy participant may prove that it has incurred the expense by submitting, along with the claim for reimbursement, an invoice or statement of services rendered by the optometrist, ophthalmologist, or other eye care service provider. In other embodiments, the Insurance Company can receive and store in a database accessible to the claim Processing Module 670 data that reflects expenses incurred by policy participants directly from eye care service providers. By using the claim information, the claim Processing Module 670 can check the database to determine whether the expense for the service was incurred by the policy participant.

If it is found that the policy participant has in fact incurred one of the routine eye care expenses covered by the vision protection policy, the claim Processing Module 670, in one embodiment, determines that the Insurance Company is to provide, in Step 704, at least partial reimbursement to the policy participant for the expenses incurred. The amount of reimbursement and the extent that these expenses are covered varies for different embodiments of the present invention. For example, in one embodiment, the policy participant is not reimbursed for any expenses incurred when undergoing a medical procedure to improve his or her vision; while in other embodiments, the policy participant may receive partial or full reimbursement for such expenses.

In Step 705 the claim Processing Module 670 determines whether the policy participant has been diagnosed with an eye disease or disorder for which coverage is provided by the vision protection policy. As discussed above, the diseases or disorders that are covered by the vision protection policy may include, for example, glaucoma, proliferative diabetic retinopathy, macular degeneration, retinal detachment, or retinitis pigmentosa. Certification of such disease or disorder may be required from the eye care provider on behalf of the policy participant or beneficiary. If the policy participant has been diagnosed with one of the covered diseases or disorders, the claim Processing Module 670 determines that the Insurance Company is to make, in Step 706, one or more eye condition benefit payments to the policy participant. In one embodiment, the one or more eye condition benefit payments include a payment of a pre-defined amount (e.g., $1000).

In Step 707, the claim Processing Module 670, in one embodiment, then determines whether the policy participant has undergone a surgical procedure related to an eye disease or disorder. Proof that the policy participant has incurred such surgical procedure may be required before payment of any benefit. Such proof may be in the form of an eye care provider's certification, for example. If the policy participant has undergone a surgical procedure related to an eye disease or disorder, in Steps 708 and 710, the claim Processing Module 670 first determines what type of surgical procedure was undergone, and then determines that the Insurance Company is to make one or more eye surgery benefit payments to the policy participant based on the type of surgical procedure undergone. For example, where the policy participant has undergone surgery to remove cataracts, the Insurance Company may provide an eye surgery benefit payment of $800.

In Step 711 the claim Processing Module 670, according to one embodiment of the present invention, determines whether the policy participant has been diagnosed with a visual impairment for which there is no, or substantially no, reasonable medical prognosis of recovery. Proof that the policy participant has suffered such visual impairment, as well as the level of impairment, may be required before payment of any benefit. If the policy participant has been so diagnosed, in Steps 712 and 714, the claim Processing Module 670 first determines the level of visual impairment that has been diagnosed, and then determines that the Insurance Company is to make at least one visual impairment payment to the policy participant based on the level of visual impairment. For example, as discussed above, a policy participant diagnosed with a Level 1 impairment (i.e., severe visual impairment) may receive up to $750 per eye; while a policy participant diagnosed with Level 4 impairment (i.e., total visual impairment) may receive up to $10,000 per eye.

If it is determined that the policy participant has not incurred expenses for routine eye care, been diagnosed with a disease or disorder, undergone a surgical procedure related to an eye disease or disorder, or been diagnosed with a visual impairment for which there is no, or substantially no, reasonable prognosis of recovery, the claim received is not valid and a denial letter is generated, after which the process ends (shown in Steps 716 and 718).

As will be understood by those of ordinary skill in the art, the steps of process described above need not be performed in the order in which they are described above. For instance, it is not necessary that the claim Processing Module 670 determine whether the policy participant has been diagnosed with an eye disease or disorder prior to determining whether the policy participant has undergone a surgical procedure or has been diagnosed with a visual impairment, as long as the necessary determinations are made to assess what benefits the policy participant should receive.

Modifications and Alternative Embodiments

Many modifications and other embodiments of the invention will come to mind to one skilled in the art to which this invention pertains having the benefit of the teachings presented in the foregoing descriptions. Accordingly, it should be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

1. A system for issuing a vision protection policy, said system comprising:
a processor; and
a memory coupled to said processor and storing an application that the processor executes to:
receive applicant data related to a prospective policy participant;
apply one or more business rules stored in said memory to said applicant data to determine whether said prospective policy participant qualifies for said vision protection policy; and
transmit said vision protection policy to a policy participant, wherein said policy participant is comprised of said prospective policy participant determined to qualify for said vision protection policy,
wherein said vision protection policy provides a combination of a routine eye care benefit and one or more of an eye condition benefit, an eye surgery benefit, and a permanent visual impairment benefit.

2. The system of claim 1, wherein said routine eye care benefit of said vision protection policy is comprised of an eye examination benefit, said eye examination benefit at least partially covering a cost associated with at least one medical examination of said policy participant's eyes.

3. The system of claim 2, wherein said routine eye care benefit of said vision protection policy is further comprised of a vision correction benefit, wherein said vision correction benefit at least partially covers a cost associated with purchasing one or more vision correction materials to be used by said policy participant.

4. The system of claim 3, wherein said vision correction benefit further provides for a vision correction payment to be made to said policy participant for said policy participant undergoing a medical procedure to improve said policy participant's vision.

5. The system of claim 1, wherein said eye condition benefit of said vision protection policy provides for one or more eye condition benefit payments to be made in response to said policy participant being diagnosed with a particular eye disease or disorder.

6. The system of claim 5, wherein said particular eye disease or disorder is selected from the group consisting of: glaucoma, cancer of the eye, proliferative diabetic retinopathy, and macular degeneration.

7. The system of claim 5, wherein said particular eye disease or disorder is selected from the group consisting of: retinal detachment and retinitis pigmentosa.

8. The system of claim 5, wherein said one or more eye condition benefit payments comprises payment of a pre-defined amount to be made to said policy participant.

9. The system of claim 1, wherein said eye surgery benefit of said vision protection policy provides for one or more eye surgery benefit payments to be made to a policy participant in response to said policy participant undergoing a surgical procedure related to a particular eye disease or disorder.

10. The system of claim 9, wherein said surgical procedure is selected from the group consisting of: cornea transplant, cataract removal, cataract discussion, and retinal detachment repair.

11. The system of claim 9, wherein said one or more eye surgery benefit payments comprises payment of a pre-determined amount to said policy participant.

12. The system of claim 1, wherein said permanent visual impairment benefit of said vision protection policy provides for at least one payment to be made in response to a policy participant being diagnosed with a visual impairment for which there is no, or substantially no, reasonable medical prognosis of recovery.

13. The system of claim 12, wherein said permanent visual impairment benefit provides for a first particular set of one or more payments to be made to said policy participant in response to said policy participant being diagnosed with a first type of visual impairment.

14. The system of claim 13, wherein said first type of visual impairment is a severe visual impairment.

15. The system of claim 13, wherein said first type of visual impairment is defined by said policy participant having a maximal visual acuity in a particular eye, after correction, of 20/200 or less, or a total diameter of the visual field in said particular eye of 20 degrees or less.

16. The system of claim 13, wherein said permanent visual impairment benefit provides for a second particular set of one or more payments to be made to said policy participant in response to said policy participant being diagnosed with a second type of visual impairment.

17. The system of claim 16, wherein said first particular set of one or more payments is different from said second particular set of one or more payments.

18. The system of claim 16, wherein said second type of visual impairment is a profound visual impairment.

19. The system of claim 16, wherein said second type of visual impairment is defined by said policy participant having a maximal visual acuity in a particular eye, after correction, of 20/500 or less, or a total diameter of the visual field in said particular eye of 10 degrees or less.

20. The system of claim 16, wherein said permanent visual impairment benefit provides for a third particular set of one or more payments to be made to said policy participant in response to said policy participant being diagnosed with a third type of visual impairment.

21. The system of claim 20, wherein said third type of visual impairment is a near-total visual impairment.

22. The system of claim 20, wherein said third type of visual impairment is defined by said policy participant having a maximal visual acuity in a particular eye, after correction, of 20/1000 or less, or a total diameter of the visual field in said particular eye of 5 degrees or less.

23. The system of claim 20, wherein said permanent visual impairment benefit provides for a fourth particular set of one or more payments to be made to said policy participant in response to said policy participant being diagnosed with a fourth type of visual impairment.

24. The system of claim 23, wherein said fourth type of visual impairment is a total visual impairment.

25. The system of claim 23, wherein said fourth type of visual impairment is defined by said policy participant having a complete loss of vision in a particular eye with no remaining perception of light, or the loss of said particular eye.

26. The system of claim 1, wherein said routine eye care benefit and said combination of an eye examination benefit, an eye surgery benefit, and a permanent visual impairment benefit are provided regardless of other insurance coverage that said policy participant may have for medical care related to said particular eye disease or disorder.

27. A system for processing a vision protection policy claim, said system comprising:
a processor; and
a memory connected to said processor and storing a computer program executed by said processor to:
(a) receive a vision protection policy claim from a policy participant;
(b) determine whether said policy participant incurred one or more expenses relating to routine eye care;
(c) determine whether said policy participant has been diagnosed with an eye disease or disorder;
(d) determine whether said policy participant has undergone a surgical procedure related to an eye disease or disorder;
(e) determine whether said policy participant has been diagnosed with a visual impairment for which there is no, or substantially no, reasonable medical prognosis of recovery; and
(f) authorize provision of some combination of a routine eye care benefit, an eye condition benefit, an eye surgery benefit, and a permanent visual impairment benefit based on the determinations made in steps (b) through (e).

28. The system of claim 27, wherein said routine eye care benefit provided in step (f) is comprised of an eye examination benefit, said eye examination benefit at least partially covering a cost associated with at least one medical examination of said policy participant's eyes.

29. The system of claim 28, wherein said routine eye care benefit provided in step (f) is further comprised of a vision correction benefit, wherein said vision correction benefit at least partially covers a cost associated with purchasing one or more vision correction materials to be used by said policy participant.

30. The system of claim 29, wherein said vision correction benefit further provides for a vision correction payment to be made to said policy participant in response to said policy participant undergoing a medical procedure to improve said policy participant's vision.

31. The system of claim 27, wherein said eye condition benefit provided in step (f) provides for one or more eye condition benefit payments to be made in response to said policy participant being diagnosed with a particular eye disease or disorder.

32. The system of claim 27, wherein said eye surgery benefit provided in step (f) provides for one or more eye surgery benefit payments to be made to a policy participant in response to said policy participant undergoing a surgical procedure related to a particular eye disease or disorder.

33. The system of claim 27, wherein said permanent visual impairment benefit provided in step (f) provides for at least one payment to be made in response to a policy participant being diagnosed with a visual impairment for which there is no, or substantially no, reasonable medical prognosis of recovery.

34. A computing device comprising:
a processor; and
a memory connected to said processor and storing a computer program executed by said processor to:
receive applicant data pertaining to a vision protection policy from a prospective policy participant; and
transmit said applicant data to an insurance company computer,
wherein said vision protection policy provides a combination of a routine eye care benefit and one or more of an eye condition benefit, an eye surgery benefit, and a permanent visual impairment benefit, and the applicant data relates to the combination of benefits.

35. The computing device of claim 34, wherein said routine eye care benefit provided by said vision protection policy is comprised of an eye examination benefit, said eye examination benefit at least partially covering a cost associated with at least one medical examination of said policy participant's eyes.

36. The computing device of claim 35, wherein said routine eye care benefit provided by said vision protection policy is further comprised of a vision correction benefit, wherein said vision correction benefit at least partially covers a cost associated with purchasing one or more vision correction materials to be used by said policy participant.

37. The computing device of claim 36, wherein said vision correction benefit further provides for a vision correction payment to be made to said policy participant in response to said policy participant undergoing a medical procedure to improve said policy participant's vision.

38. The computing device of claim 34, wherein said eye condition benefit provided by said vision protection policy provides for one or more eye condition benefit payments to be made in response to said policy participant being diagnosed with a particular eye disease or disorder.

39. The computing device of claim 34, wherein said eye surgery benefit provided by said vision protection policy provides for one or more eye surgery benefit payments to be made to a policy participant in response to said policy participant undergoing a surgical procedure related to a particular eye disease or disorder.

40. The computing device of claim 34, wherein said permanent visual impairment benefit provided by said vision protection policy provides for at least one payment to be made in response to a policy participant being diagnosed with a visual impairment for which there is no, or substantially no, reasonable medical prognosis of recovery.
